(19) United States
(12) Patent Application Publication
(10) Pub. No.: US 2016/0292666 A1
(43) Pub. Date: Oct. 6, 2016

(54) METHOD AND SYSTEM FOR DETERMINING AND ASSESSING GEOLOCATION PROXIMITY

(71) Applicant: MASTERCARD INTERNATIONAL INCORPORATED, Purchase, NY (US)

(72) Inventor: Rohit Chauhan, Somers, NY (US)

(21) Appl. No.: 14/674,744

(22) Filed: Mar. 31, 2015

(51) Int. Cl. G06Q 20/32; G06Q 20/34; H04W 76/02; H04B 5/00; H04W 4/00; G06Q 20/20; H04W 4/02

(52) U.S. Cl. CPC G06Q 20/3224; G06Q 20/204; G06Q 20/202; G06Q 20/3278; G06Q 20/34; H04W 4/02; H04B 5/0031; H04W 4/008; H04W 76/023

(57) ABSTRACT

A method and a system are provided for authenticating secure payment card transactions and verifying and validating payment card user identities. The method includes receiving information from a transaction device involving a payment card holder initiating a payment card transaction at a merchant using a mobile device having a Near Field Communication (NFC) circuit that is communicatively coupled thereto; determining coordinate location of the merchant by leveraging a physical address of the merchant; determining coordinate location of the mobile device using an application programming interface (API) framework that is sufficient to support communication with a cellular phone communication provider; comparing the coordinate location of the merchant with the coordinate location of the mobile device to determine a relative degree of proximity of the merchant with the mobile device; and assessing the determined relative degree of proximity to facilitate determining whether the payment card transaction using the mobile device is valid or invalid (e.g., potential fraud).

### BACKGROUND OF THE DISCLOSURE

1. Field of the Disclosure

The present disclosure relates to systems and methods directed to location-based services in a wireless telecommunications or data communications network and, in particular, to determining and assessing geolocation proximity. More particularly, the present disclosure relates to such systems and methods directed to authenticating location-based services in a variety of spaces or technologies, such as authenticating secure payment card transactions, verifying and validating payment card user identities, and comparing the results of two or more geographic locations to provide utility or value.

2. Description of the Related Art

Payment card companies and merchants incur billions of dollars in losses each year from payment card fraud. Fraud is particularly high in the world of ecommerce where no payment card is actually presented for verification and the actual identity of the user performing the transaction is very difficult, if not impossible, to verify.

Some current fraud mitigation techniques include, for example, merchants requesting a payment card holder's zip code and payment card verification value (CVV) information to verify the identity of the payment card holder. Unfortunately, in a majority of the instances in which the payment card or the payment card number gets compromised, this information also gets compromised, thus reducing the efficacy of these additional pieces of information.

Another technique is for payment card companies to build detailed expensive models on payment card holder behaviors around purchase patterns (things they buy, stores they frequent, etc.) and geolocation movements (places the payment card holder typically travels to). These behaviors are compiled over time and continually evolve. The purchase models are used to detect fraud early and alert merchants and payment card holders. However, the models take months, if not years, to be built for each user and often result in false positives when a user breaks their pattern.

There exists a myriad of current methods that provide for authentication, verification and validation of user activity as well as for user identity. These technologies are used to ensure that an individual is the actual person claimed for the benefit of the activity or transaction. Today, many employed technologies have greatly reduced fraudulent transactions, however instances of fraudulent activity still occur. These technologies are employed, for example, when an individual engages in some transaction that requires some degree of security. An automated financial transaction is a common example of a secure transaction requiring mechanisms to authenticate, verify and validate the identity of the individual attempting to perform the transactional activity. Primary examples of such transactions include performing some banking function, using payment cards (e.g., credit or debit cards) at a point of sale (POS) to make a purchase, that require some form of authentication, verification and validation.

Typical means that are used to authenticate individuals attempting a secure transaction include use of personal identification numbers (PINs) or some other type of information that is assumed to be known only by an authorized user involved in the transaction. Other means of documentation may also be used to verify identity, such as a driver's license or other form of photo identification. Even the use of biometric devices, such as fingerprint scanners, may be used to authenticate an individual attempting to perform a secure transaction. However, even with these and many other technologies employed, fraudulent activity still occurs, and identity theft and misrepresentation remains a problem.

As indicated above, many existing fraud detection and prevention technologies can and do provide a false positive indication of fraudulent activity. Besides the fraud detection and prevention mechanisms already mentioned, other technologies may be employed such as behavioral profiling that is used to detect anomalous behavior. These technologies employ intelligent algorithms to analyze past user behavior when a user attempts to engage in some activity or transaction that is similar to a previous activity or transaction. If the individual's behavior when engaging in a secure activity is not consistent with that individual's past behavior, a likelihood of fraudulent activity may be deduced.

Common examples of this situation are when an individual uses a payment card to purchase some product or service in a foreign country where they have never previously performed a similar transaction. Or, the amount of a particular transaction is significantly different from any previous transaction. This behavior may appear anomalous to a fraud detection system and the activity or transaction being performed may be terminated before any potential fraud is perpetrated. If this is in fact a false positive indication and the individual is actually an authorized user, the user suffers the consequences of a failed transaction and the service provider is perceived to have provided a poor quality of service.

Also, payment cards can be stolen and/or PINs can become compromised and information meant to be held only by authorized users can become known to others. The reality is that other means to perform authentication, verification and validation of authorized users to assist in an authentication process continues to have relevance for transactions where fraudulent activity remains a problem.

There is a need for additional and improved systems and methods to assist, for example, with fraud management systems and identity recognition and authentication. These systems are employed in a variety of industries, including banking and finance, commerce, security and others. In many cases, existing technologies employ detection methods as opposed to prevention methods. That is, many technologies and systems currently in place attempt to detect some fraudulent activity after it has occurred, and then prevent similar fraudulent activity in the future based on this detection. These methods are not optimal as fraudulent activity can be successful in at least one instance prior to detection and subsequent prevention. The prevention of the fraudulent activity at the first attempt to do so, is certainly preferable, as well as reducing incidences of false positive indications of fraud. No present fraud detection and prevention system is perfect. Thus, there is always a need to employ additional technologies to further reduce fraud and identity theft, thereby reducing the economic impact of such undesired activity.

### SUMMARY OF THE DISCLOSURE

The present disclosure provides systems and methods directed to location-based services in a wireless telecommunications or data communications network and, in particular, to determining and assessing geolocation proximity.

The present disclosure also provides such systems and methods directed to authenticating location-based services in a variety of spaces or technologies in a wireless telecommunications or data communications network, such as authenticating secure payment card transactions, verifying and validating payment card user identities, and comparing the results of two or more geographic locations to provide or determine some utility or value. The present disclosure further provides methods and systems for payment card fraud alerting that are location-based.

The present disclosure still further provides a method that includes receiving information from a transaction device (e.g., a merchant point-of-sale (POS) terminal) involving a payment card holder initiating a payment card transaction at a merchant using a mobile device (e.g., a cell phone or a smart phone). A Near Field Communication (NFC) circuit is communicatively coupled to the mobile device. The NFC circuit includes at least one of a NFC tag and a NFC reader to receive or selectively provide wireless connectivity data from or to the transaction device via a NFC communication link. The method further includes determining coordinate location of the merchant by leveraging a physical address of the merchant; determining coordinate location of the mobile device using an application programming interface (API) framework that is sufficient to support communication with a cellular phone communication provider; comparing the coordinate location of the merchant with the coordinate location of the mobile device to determine a relative degree of proximity of the merchant with the mobile device; and assessing the determined relative degree of proximity to facilitate determining whether the payment card transaction using the mobile device is valid or invalid (e.g., potential fraud). The mobile device establishes a communication link with the transaction device in accordance with communication configuration information received by the NFC circuit via the NFC communication link. The API framework permits, for example, a payment provider server to access a cellular phone communication provider server and obtain longitude and latitude coordinates of a cellular phone that has been used in a payment card transaction.

The present disclosure yet further provides a method for authentication of a payment card transaction. The method includes receiving information from a transaction device (e.g., a merchant POS terminal) involving a payment card holder initiating a payment card transaction at a merchant using a mobile device (e.g., a cell phone or a smart phone). A NFC circuit is communicatively coupled to the mobile device. The NFC circuit includes at least one of a NFC tag and a NFC reader to receive or selectively provide wireless connectivity data from or to the transaction device via a NFC communication link. The method further includes determining coordinate location of the merchant by leveraging a physical address of the merchant; determining coordinate location of the mobile device using an API framework that is sufficient to support communication with a cellular phone communication provider; comparing the coordinate location of the merchant with the coordinate location of the mobile device to determine a relative degree of proximity of the merchant with the mobile device; and assessing the determined relative degree of proximity to facilitate determining whether the payment card transaction using the mobile device is valid or invalid (e.g., potential fraud). The mobile device establishes a communication link with the transaction device in accordance with communication configuration information received by the NFC circuit via the NFC communication link. The API framework permits, for example, a payment provider server to access a cellular phone communication provider server and obtain longitude and latitude coordinates of a cellular phone that has been used in a payment card transaction.

The present disclosure yet still further provides a system that includes a computer storage storing information for a plurality of payment card holders and a plurality of merchants. The information for at least one of the payment card holders comprises information about location of a mobile device used for initiating a payment card transaction at a merchant, and the information for at least one of the merchants comprises information about location of the merchant or the payment card transaction using the mobile device. The system also includes a processor coupled to the computer storage operable to receive information from a transaction device (e.g., a merchant POS terminal) involving a payment card holder initiating a payment card transaction at a merchant using a mobile device (e.g., a cell phone or a smart phone). A NFC circuit is communicatively coupled to the mobile device. The NFC circuit includes at least one of a NFC tag and a NFC reader to receive or selectively provide wireless connectivity data from or to the transaction device via a NFC communication link. The processor is coupled to the computer storage and configured to: determine coordinate location of the merchant by leveraging a physical address of the merchant; determine coordinate location of the mobile device using an API framework that is sufficient to support communication with a cellular phone communication provider; compare the coordinate location of the merchant with the coordinate location of the mobile device to determine a relative degree of proximity of the merchant with the mobile device; and assess the determined relative degree of proximity to facilitate determining whether the payment card transaction using the mobile device is valid or invalid (e.g., potential fraud). The mobile device establishes a communication link with the transaction device in accordance with communication configuration information received by the NFC circuit via the NFC communication link. The API framework permits, for example, a payment provider server to access a cellular phone communication provider server and obtain longitude and latitude coordinates of a cellular phone that has been used in a payment card transaction.

The present disclosure also provides a non-transitory machine-readable medium that includes a plurality of machine-readable instructions which when executed by one or more processors of a server are adapted to cause the server to perform a method. The method includes receiving information from a transaction device (e.g., a merchant POS terminal) having a payment card holder initiating a payment card transaction at a merchant using a mobile device (e.g., a cell phone or a smart phone). A NFC circuit is communicatively coupled to the mobile device. The NFC circuit includes at least one of a NFC tag and a NFC reader to receive or selectively provide wireless connectivity data from or to the transaction device via a NFC communication link. The method also includes determining coordinate location of the merchant by leveraging a physical address of the merchant; determining coordinate location of the mobile device using an API framework that is sufficient to support communication with a cellular phone communication provider; comparing the coordinate location of the merchant with the coordinate location of the mobile device to determine a relative degree of proximity of the merchant with the mobile device; and assessing the determined relative degree of proximity to facilitate determining whether the payment card transaction using the mobile device is valid or invalid (e.g., potential fraud). The mobile device establishes a communication link with the transaction device in accordance with communication configuration information received by the NFC circuit via the NFC communication link. The API framework permits, for example, a payment provider server to access a cellular phone communication provider server and obtain longitude and latitude coordinates of a cellular phone that has been used in a payment card transaction.

The present disclosure additionally provides a non-transitory machine-readable medium that comprises a plurality of machine-readable instructions which when executed by one or more processors of a server can cause the server to perform a method.

In an exemplary embodiment of this disclosure, when a payment transaction is triggered by a consumer by tapping a mobile device (e.g., cell phone) on the merchant transaction device (e.g., POS device) that accepts NFC payments, an authorization message sent from the POS terminal will include the cell phone number, the cell phone carrier along with all other fields that are typically included in the authorization message. When the authorization message reaches a payment provider, such as a payment card company like MasterCard®, Visa®, American Express®, and the like, the following analysis is conducted: the coordinate location of the merchant (latitude and longitude) is calculated by leveraging the address of the merchant; an API call is made to the cell phone carrier with the cell phone number as the input variable and get back the coordinate location of the cell phone (latitude and longitude); a location analysis is conducted by comparing the coordinate location of the merchant with the coordinate location of the cell phone; and a relative degree of proximity of the merchant with the cell phone is determined. If the location analysis is true (same location or within certain tolerance level), the authorization message is tagged with flag. The location analysis flag is leveraged along with other criteria to authorize or decline the payment transaction.

Further, in the above exemplary embodiment of this disclosure, the payment card holder mobile device includes a NFC circuit that is communicatively coupled to the mobile device. The NFC circuit includes at least one of a NFC tag and a NFC reader to receive or selectively provide wireless connectivity data from or to the transaction device via a NFC communication link. The mobile device establishes a communication link with the transaction device in accordance with communication configuration information received by the NFC circuit via the NFC communication link. Likewise, the transaction device includes a NFC circuit that is communicatively coupled to the transaction device. The NFC circuit includes at least one of a NFC tag and a NFC reader to receive or selectively provide wireless connectivity data from or to the transaction device via a NFC communication link. The transaction device establishes a communication link with the mobile device in accordance with communication configuration information received by the NFC circuit via the NFC communication link.

These and other features and advantages of the present disclosure will be more readily apparent from the detailed description of the embodiments set forth herein.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 is a flow diagram illustrating one environment of a process for payment card fraud alerting in accordance with an exemplary embodiment of this disclosure.

FIG. 4 is a block diagram of a system suitable for implementing the processes described herein according to an embodiment of this disclosure.

FIG. 5 illustrates components of an exemplary API or interface in accordance with an exemplary embodiment of this disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of this disclosure are shown. Indeed, this disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

Where applicable, the steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

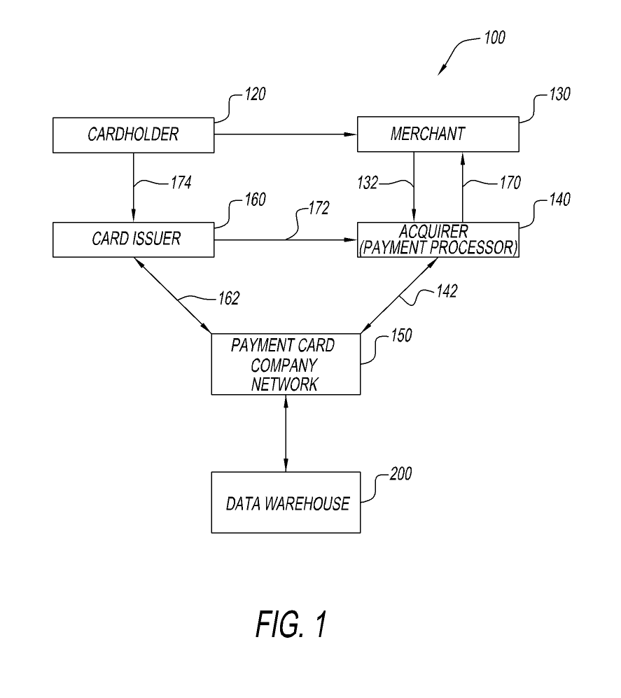

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, merchant category and merchant geolocation for every transaction occurring within payment card network 150. In addition to payment card transaction information and merchant information, data warehouse 200 can also store external information such as geographic and demographic information (e.g., gender and age).

In yet another embodiment, data warehouse 200 stores, reviews, and/or analyzes information used in (i) determining coordinate location of the merchant by leveraging a physical address of the merchant, (ii) reviewing coordinate location of the mobile device received through the API framework from the cellular phone communication provider, (iii) comparing the coordinate location of the merchant with the coordinate location of the mobile device to determine a relative degree of proximity of the merchant with the mobile device, and (iv) assessing the determined relative degree of proximity to facilitate determining whether the payment card transaction using the mobile device is valid or invalid (e.g., potential fraud).

In another embodiment, data warehouse 200 stores, reviews, and/or analyzes information used in developing logic for (i) determining coordinate location of the merchant by leveraging a physical address of the merchant, (ii) assessing coordinate location of the mobile device received through the API framework from the cellular phone communication provider, (iii) comparing the coordinate location of the merchant with the coordinate location of the mobile device to determine a relative degree of proximity of the merchant with the mobile device, and (iv) assessing the determined relative degree of proximity to facilitate determining whether the payment card transaction using the mobile device is valid or invalid (e.g., potential fraud).

In another embodiment, data warehouse 200 aggregates the information by payment card holder, mobile device, merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

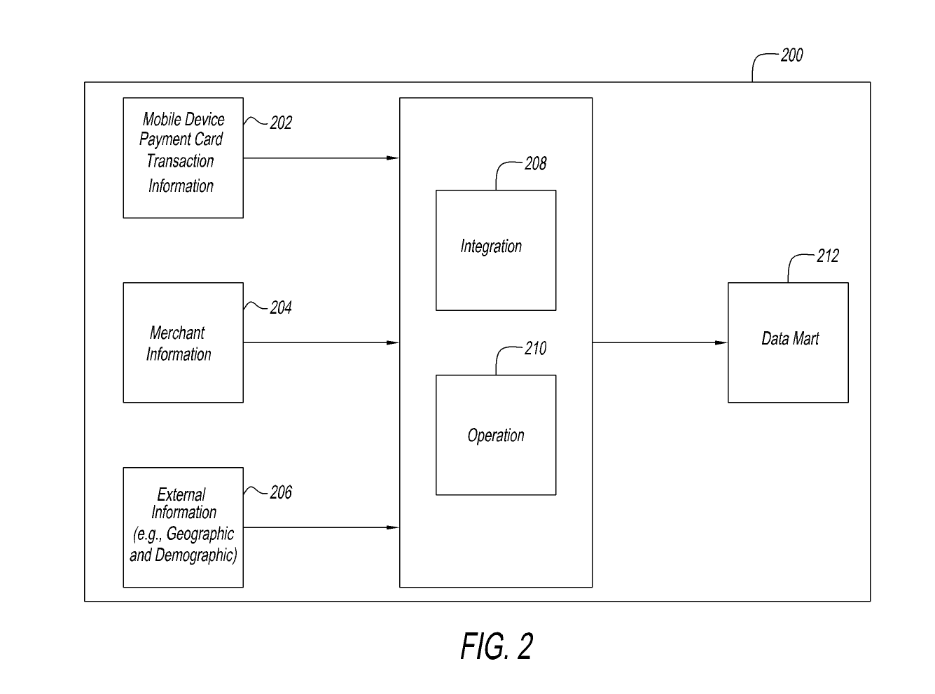

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202, 204 and 206).

The payment card transaction information 202 can include, for example, payment card holder information, and purchasing and payment activities attributable to payment card holders, that can be aggregated by payment card holder, mobile device, merchant, category and/or location in the data warehouse 200. The payment card transaction information 202 can also include, for example, a transaction identifier, geolocation of payment card transaction, geolocation date on which payment card transaction occurred, geolocation time on which payment card transaction occurred, payment card number, mobile phone number, and the like.

The merchant information 204 can include, for example, a merchant name or identifier, geolocation of merchant, merchant category, and the like.

The external information 206 includes, for example, geographic data and demographic data. The external information 206 can include other suitable information that can be useful in assisting with fraud management systems and identity recognition and authentication.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by mobile device, merchant, category and/or location at 208, and the merchant information can be aggregated by merchant name or identifier, geolocation of merchant, and merchant category at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

According to one embodiment, data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can include data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas, in turn, can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

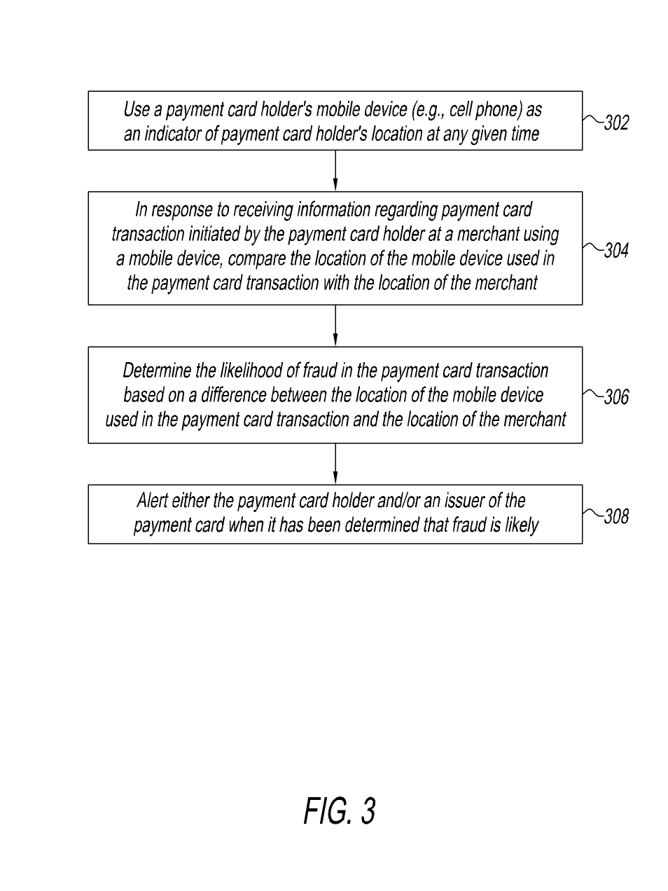

FIG. 3 illustrates one exemplary environment of a process for payment card fraud alerting. The exemplary embodiment recognizes that the location of a payment card holder is a critical piece of information that can alleviate significant amounts of fraud (as it is rare for a payment card holder associated with a cell phone to be too far from his or her cell phone, especially when the cell phone is used in the payment card transaction). With the widespread adoption of mobile devices, such as a cell phone and more importantly smart phones, the exemplary embodiment uses a payment card holder's cell phone at 302 as an indicator of the payment card holder's location at any given time. The location (e.g., coordinate location) of a mobile device used in a payment card transaction can be obtained through an API framework that is sufficient to support communication with a cellular phone communication provider. In an embodiment, determining the coordinate location of the mobile device involves obtaining longitude and latitude coordinates from the cellular phone communication provider through the API framework.

The location of the payment card holder's cell phone used in the payment card transaction can be obtained, in one embodiment, after a payment provider, such as a payment card company like MasterCard®, Visa®, American Express®, and the like (part of the payment card company network 150 in FIG. 1), receives a payment request from a transaction device. The payment request can be from a merchant or another user device, where the payment request includes information about the transaction, the seller or merchant identification, an amount of the transaction, and the like. The location (e.g., coordinate location) of the merchant can be determined by leveraging a physical address of the merchant based on the merchant identification. Determining the coordinate location of the merchant involves determining longitude and latitude coordinates from the information from the transaction device involving the payment card holder initiating the payment card transaction at the merchant using the mobile device.

In response to receiving information regarding the payment request or payment card transaction of the payment card holder, the exemplary embodiment compares at 304 the location of the mobile device used in the payment card transaction with the location of the merchant.

A likelihood of fraud in the payment card transaction is then determined at 306 based on a difference between the location of the mobile device used in the payment card transaction with the location of the merchant. This difference can vary, depending on system fraud requirements, payment card holder settings, accuracy or resolution of the location determinations, and the like. For example, if the distance between the location of the mobile device used in the payment card transaction and the location of the merchant is more than 250 or 500 meters, a possible fraud can be identified.

In a comparison of the location of the mobile device used in the payment card transaction with the location of the merchant, if the location comparison results demonstrate close proximity of the mobile device with the merchant, a reasonable assertion can be made that the payment card user is authentic, or the payment card transaction being performed is valid. In contrast, if the location comparison results demonstrate far proximity of the mobile device with the merchant, a reasonable assertion can be made that the payment card user is not authentic, or the payment card transaction being performed is invalid (e.g., potential fraud).

When it has been determined that fraud is likely, one of the following: the payment card holder, the merchant/seller, and/or an issuer of the payment card, can be alerted at 308. The alert can be through a text, email, or call to the payment card holder mobile device, the merchant, and/or the payment card issuer. In one embodiment, the payment card holder can be notified and given the option of authorizing the payment, such as by verifying the payment card holder through an authentication or login flow with the payment provider through the payment card holder mobile device.

The present solution utilizes the real time location of a payment card holder's cell phone used in the payment card transaction and compares it against the location of the merchant to determine the propensity for fraud in a given transaction. The location of the payment card holder's mobile device (e.g., a cell phone, a watch phone, and the like) can be derived through an API framework that is sufficient to support communication with a cellular phone communication provider. In an embodiment, determining the coordinate location of the mobile device involves obtaining longitude and latitude coordinates from the cellular phone communication provider through the API framework.

The location (e.g., coordinate location) of the merchant can be determined by leveraging a physical address of the merchant. Determining the coordinate location of the merchant involves determining longitude and latitude coordinates from the information from the transaction device involving the payment card holder initiating the payment card transaction at the merchant using the mobile device.

Knowing the location of the mobile device used in the transaction and comparing it to the location of the merchant, at the time of the transaction can vastly improve decision making on the legitimacy of the transaction. Because a payment card holder is assumed to always be near or have in his or her possession the payment card holder's cell phone, especially when the cell phone is used in the payment card transaction, the location of the cell phone is assumed to be the payment card holder's approximate location. Consequently, if a payment request is made by the payment card holder or on behalf of the payment card holder at a location far from the payment card holder's cell phone, the payment provider can assume a potential of a fraudulent payment request.

In a store purchase scenario, when a payment card holder uses a mobile device at a store to pay for goods/services, the physical location of the merchant/service provider is sent the bank/financial institution/payment provider and onto a server in the fraud alerting system where the physical location of the merchant/service provider is compared against the location of the payment card holder's cell phone in real-time. If the distance between the mobile device and the merchant address is significant, an alert can be generated and sent to the mobile phone and/or the transaction can be pushed into a review queue or rejected.

Each merchant terminal contains a terminal ID and has a designated merchant address that is part of the transaction. At the time of the transaction, this terminal address is geolocation coded into a latitude/longitude. The latitude/longitude of the merchant is then compared to the latitude/longitude of the mobile device. The mobile device location can be aged on an exponential scale (1/log (n)), so information that is current (recent) results in a high confidence; however location information that is hours or days old bears almost no confidence since the payment card holder may have moved. Confidence can be assigned by 1/(Log(current time-time of last location recording)+1). If the confidence is low, the system can attempt to obtain a current location of the payment card holder mobile device/cell phone used in the transaction.

The distance between the merchant location and the mobile phone location can be computed to determine the likelihood of the payment card holder being present at the POS terminal.

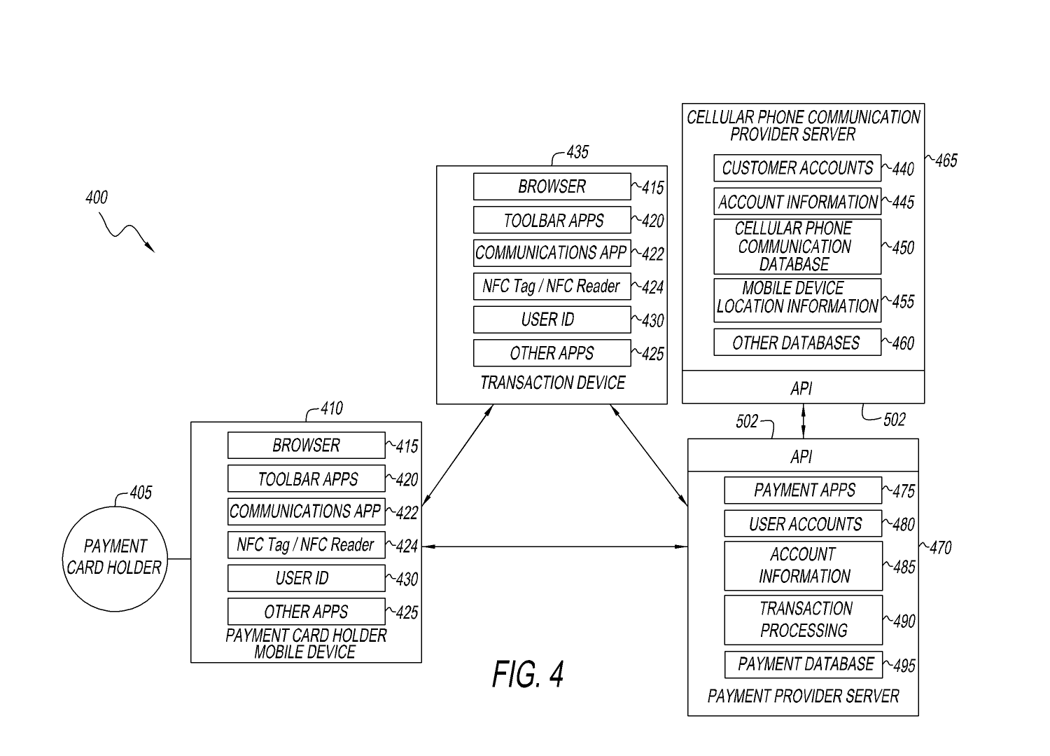

Referring to FIG. 4, a system 400 is configured to process a financial transaction or payment request between a payment recipient (e.g., merchant) and a payment card holder or consumer, in accordance with an exemplary embodiment of the present disclosure. System 400 includes a mobile device 410 used to make the payment card transaction, a merchant transaction device 435, and a payment provider server 470. Payment provider server 470 can be maintained by a payment provider, such as a payment card company like MasterCard®, Visa®, American Express®, and the like (part of the payment card company network 150 in FIG. 1), a bank, and the like. A payment card holder 405, such as a consumer, can utilize payment card holder mobile device 410 and merchant transaction device 435 to perform a payment transaction using payment provider server 470 or to convey a desire to make a payment through the payment provider so that the payment provider can process the payment request and approve or deny the request.

Payment card holder mobile device 410, merchant transaction device 435, and payment provider server 470 can each include one or more processors, memories, and other appropriate components for executing instructions, such as program code and/or data stored on one or more computer readable mediums to implement the various applications, data, and steps described herein. For example, such instructions can be stored in one or more computer readable media, such as memories or data storage devices internal and/or external to various components of system 400.

Payment card holder mobile device 410 can be implemented using any appropriate hardware and software configured for wired and/or wireless communication. For example, in one embodiment, the payment card holder mobile device can be implemented as a smart phone (e.g., iPhone™ 6), personal digital assistant (PDA), laptop computer, and/or other types of computing devices capable of transmitting and/or receiving data, such as an iPad™ or Apple™ watch. The payment card holder initiates a payment card transaction at the merchant transaction device 435 using the mobile device 410.

Payment card holder mobile device 410 can include one or more browser applications 415. For example, in one embodiment, browser application 415 can be implemented as a web or mobile browser configured to view information available over the Internet. Payment card holder mobile device 410 can also include one or more toolbar applications 420 which can be used, for example, to provide client-side processing for performing desired tasks in response to operations selected by payment card holder 405. In one embodiment, toolbar application 420 can display a user interface in connection with browser application 415.

Payment card holder mobile device 410 can further include other applications 425 as may be desired in particular embodiments to provide desired features to payment card holder mobile device 410. For example, other applications 425 can include security applications for implementing client-side security features, programmatic client applications for interfacing with appropriate APIs, or other types of applications. Applications 425 can also include email, texting, voice and IM applications that allow payment card holder 405 to send and receive emails, calls, and texts, as well as applications that enable the payment card holder to communicate, make payments, and change payment options through the payment provider.

Payment card holder mobile device 410 includes one or more payment card holder identifiers 430 that can be implemented, for example, as operating system registry entries, cookies associated with browser application 415, identifiers associated with hardware of payment card holder mobile device 410, or other appropriate identifiers, such as used for payment/user/device authentication. In one embodiment, payment card holder identifier 430 can be used by a payment service provider to associate payment card holder 405 with a particular account maintained by the payment provider as further described herein. A communications application 422, with associated interfaces, enables payment card holder mobile device 410 to communicate within system 400, such as via a cell phone network. Communications application 422 can also include a GPS service or other location service that enables the location of payment card holder mobile device 410 to be determined by payment provider server 470. Note that in different embodiments, payment card holder mobile device 410 can be a simple cell phone with includes, at a minimum, a location determining application and may not require some the applications and capabilities above.

Payment card holder mobile device 410 includes a Near Field Communication (NFC) circuit that is communicatively coupled to the mobile device 410. The NFC circuit includes at least one of a NFC tag 424 and a NFC reader 424 to receive or selectively provide wireless connectivity data from or to the transaction device 435 via a NFC communication link. The mobile device 410 establishes a communication link with the transaction device 435 in accordance with communication configuration information received by the NFC circuit via the NFC communication link.

Transaction device 435 is a merchant terminal such as a POS. Transaction device 435 is the device that transmits a payment request to the payment provider on behalf of the payment card holder.

Transaction device 435 includes a Near Field Communication (NFC) circuit that is communicatively coupled to the transaction device 410. The NFC circuit includes at least one of a NFC tag and a NFC reader 424 to receive or selectively provide wireless connectivity data from or to the transaction device 435 via a NFC communication link. The transaction device 435 establishes a communication link with the mobile device 410 in accordance with communication configuration information received by the NFC circuit via the NFC communication link.

Payment provider server 470 can be maintained, for example, by a payment card company like MasterCard®, Visa®, American Express®, and the like (part of the payment card company network 150 in FIG. 1), or bank, which can provide payment between payment card holder 405 and the operator of transaction device 435. In this regard, payment provider server 470 includes one or more payment applications 475 that can be configured to interact with payment card holder mobile device 410, transaction device 435, and/or merchant server 440 over network 460 to facilitate the purchase of goods or services by payment card holder 405 through payment card holder mobile device 410 or transaction device 435.

Payment provider server 470 also maintains a plurality of payment card holder accounts 480, each of which can include account information 485 associated with individual payment card holders. For example, account information 485 can include private financial information of payment card holders associated with mobile devices such as account numbers, passwords, device identifiers, payment card holder names, phone numbers, payment card information, bank information, or other financial information that can be used to facilitate transactions by payment card holder 405. Advantageously, payment application 475 can be configured to interact with transaction device 435 on behalf of payment card holder 405 during a transaction with checkout application to track and manage payment requests from the payment card holder. Payment card holder accounts can also include information about one or more mobile devices associated with the payment card holder and the payment card holder account, such as a mobile device ID, current location of device, history of device locations, and other information about device location as described herein, such as direction of movement.

A transaction processing application 490, which can be part of payment application 475 or separate, can be configured to receive information from a payment card holder's mobile device 410 and/or transaction device 435 for processing and storage in a payment database 495. Transaction processing application 490 can include one or more applications to process information from payment card holder 405 for processing a payment request or one or more locations of payment card holder mobile device 410 and/or transaction device 435. As such, transaction processing application 490 can store details of a payment request, including merchant location and device locations to determine a possible fraud alert for the transaction. Payment application 475 can be further configured to determine the existence of and to manage accounts for payment card holder 405, as well as create new accounts if necessary.

Payment database 495 can store transaction details from completed transactions, including location of the transaction and payment card holder's mobile device 410. Such information can also be stored in a third party database accessible by the payment provider and/or the merchant.

Payment provider server 470 also includes an API or interface 502. The location (e.g., coordinate location) of a mobile device used in a payment card transaction can be obtained through the API framework or interface 502 from a cellular phone communication provider. The API framework is sufficient to support communication with a cellular phone communication provider. In an embodiment, determining the coordinate location of the mobile device involves obtaining longitude and latitude coordinates from the cellular phone communication provider through the framework or interface 502.

The cellular phone communication provider has a cellular phone communication provider server 465 that can maintain, for example, a plurality of customer accounts 440, customer account information 445, a cellular phone communication provider database 450, mobile device (e.g., cellular phone) location 455 information including coordinate location information, and other databases 460.

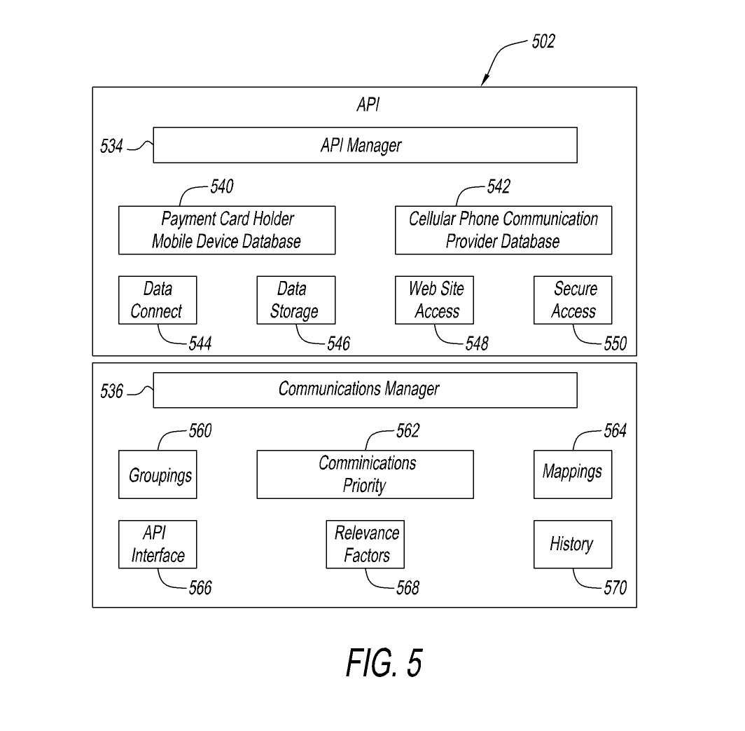

Of importance to the payment provider server interface and the cellular phone communication provider server interface is the API or interface 502 that represents hardware (including a connection path) and software that can be present at a plurality of locations to permit the payment provider server 470 to access the cellular phone communication provider server 465 and obtain longitude and latitude coordinates of a cellular phone that has been used in a payment card transaction. FIG. 5 illustrates components of an exemplary API or interface 502 that can be used in the method and system of this disclosure.

The coordinate location of the merchant can then be compared with the coordinate location of the mobile device to determine a relative degree of proximity of the merchant with the mobile device. The determined relative degree of proximity can then be assessed to facilitate determining whether the payment card transaction using the mobile device is valid or invalid (e.g., potential fraud).

In an exemplary embodiment, when a payment transaction is triggered by a consumer by tapping the mobile device 410 (e.g., cell phone) on the merchant transaction device 435 (e.g., point of sale (POS) device) that accepts NFC payments, an authorization message sent from the POS terminal will include the cell phone number, the cell phone carrier along with all other fields that are typically included in the authorization message (e.g., the address (street, city, ZIP) of the merchant is typically included in the authorization message).

When the authorization message reaches the payment provider, such as a payment card company like MasterCard®, Visa®, American Express®, and the like (part of the payment card company network 150 in FIG. 1), the following analysis can be conducted: calculate the coordinate location of the merchant (latitude and longitude) leveraging the address of the merchant; make an API call to the cell phone carrier with the cell phone number as the input variable and get back the coordinate location of the cell phone (latitude and longitude); conduct a location analysis by comparing the coordinate location of the merchant with the coordinate location of the cell phone; and determine a relative degree of proximity of the merchant with the cell phone. If the location analysis is true (same location or within certain tolerance level), the authorization message is tagged with flag. The location analysis flag is leveraged along with other criteria to authorize or decline the transaction.

FIG. 5 illustrates components of an exemplary API or interface 502 that can be used in the method and system of this disclosure. Coordinate locations of mobile devices can be obtained by, for example, a payment card company like MasterCard®, Visa®, American Express®, and the like (part of the payment card company network 150 in FIG. 1) from a cellular phone communication provider using the API. The API framework that is sufficient to support communication with a cellular phone communication provider.

The API or interface 502 includes, for example, an API manager 534 and a communications manager 536. API manager 534 includes separate items that can be accessed and available to and from data warehouse 200. For example, API manager 534 includes: a payment card holder mobile device database 540; a cellular phone communication provider database 542; a data connect function 544; a data storage 546; a web site access function 548 (e.g., cellular phone communication provider); and a web site secure access function 550. Web site access function 548 can include public, private and other APIs, in particular, those that are helpful in accessing and obtaining coordinate locations of mobile devices from cellular phone communication providers. Secure access function 550 provides varying levels of security for the API or interface 502. Secure access function 550 can include both secure and non-secure areas for various information.

Communications manager 536 includes a number of functions, such as: groupings 560 for specifying factors to be used for grouping cellular phone communication providers and information and data obtained from cellular phone communication providers (e.g., coordinate locations of mobile devices); communications priority 562 for specifying a preferred order of cellular phone communication providers and communications with cellular phone communication providers; mappings 564 for specifying how to map cellular phone communication providers and communications with cellular phone communication providers to particular groupings; an API interface 566 for interfacing the API or interface 502 to other components; relevance factors 568 for specifying the relevance of various cellular phone communication providers and communications with cellular phone communication providers; and history 570 that stores a history of cellular phone communication providers and communications with cellular phone communication providers. An event log can be associated with history 570.

The present disclosure provides methods and systems for payment card fraud alerting based on a payment card holder's location. Aspects of exemplary environment include using a location of a payment card holder's mobile device to obtain an indication of a location of the payment card holder, in response to receiving information regarding payment card or other transaction of the payment card holder; comparing the location of the payment card holder with a location of the merchant or place of the payment card transaction; determining a likelihood of fraud in the payment card transaction based on a difference between the location of the mobile device and the location of the merchant; and alerting at least one of the payment card holder and an issuer of the payment card when a likelihood of fraud has been determined.

In accordance with this disclosure, the location of the merchant or payment card transaction can include a physical location of a merchant for in-store transaction.

Depending on the resolution of the geographic locations where an activity or payment card transaction occurs, varying degrees of confidence can be ascertained as to the authenticity of that activity or payment card transaction. False positive indications of anomalous behavior can also be avoided. An example is when an individual performs an activity or payment card transaction and that individual is in a significantly different location than previously visited but that individual is in fact who he/she claims to be.

Besides the mitigation of fraudulent activity, knowledge of the location of one or more individuals for use in value-added applications can be useful. Such knowledge of the location of a wireless device, the location of the merchant, as well as the location of the wireless device user performing some automated activity or payment card transaction, can provide utility regardless of whether that activity requires security. Many value-added applications can benefit from such comparative geographic location information, such as social networking applications where it may be desirable for an individual to know the proximity of friends with which they wish to communicate. These friends can be engaging in some automated activity where the application is connected to a computer network where location information can be ascertained or they can be wireless device users themselves where the location of their wireless devices can be obtained from the same or another wireless network.

In accordance with this disclosure, the automated fraud detection and prevention systems can assign a value or range of values indicating the likelihood of fraudulent activity. These assigned values can depend on the security level required for a particular payment card transaction or activity as well as the methods used to indicate fraud. Such a mechanism can also be employed when the comparison of two or more locations, at least one being the location of a wireless device obtained from a wireless network, results in the ability to ascertain varying degrees of confidence based on the proximity of the two geographic locations being compared.

In particular, if the location comparison results demonstrate close proximity of a mobile device to the merchant or payment card transaction being performed, a reasonable assertion can be made that the payment card user is authentic, or the payment card transaction being performed is valid. In contrast, if the location comparison results demonstrate far proximity of the mobile device to the merchant or payment card transaction being performed, a reasonable assertion can be made that the payment card user is not authentic, or the payment card transaction being performed is invalid (e.g., potential fraud).

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the scope of the present disclosure. In addition, where applicable, it is contemplated that software components can be implemented as hardware components and vice-versa.

Software, in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

It will be understood that the present disclosure can be embodied in a computer readable non-transitory storage medium storing instructions of a computer program which when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on”.

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

1. A method comprising:
receiving a payment request from a transaction device configured to receive communications by Near Field Communication (NFC) for a payment card holder initiating a payment card transaction at a merchant using a mobile device, wherein the transaction device is at a physical location of the merchant;
communicatively coupling an NFC circuit to the mobile device, the NFC circuit including at least one of a NFC tag and a NFC reader to receive or selectively provide wireless connectivity data from or to the transaction device via an NFC communication link;
determining a coordinate location of the merchant by correlating a physical address of the merchant with a latitude and longitude;
obtaining a coordinate location of the mobile device by an application programming interface (API) framework that supports communication with a cellular phone communication provider, wherein the coordinate location of the mobile device is aged on an exponential scale to provide a confidence level of the coordinate location of the mobile device;
comparing the coordinate location of the merchant with the coordinate location of the mobile device to determine a determined distance between the coordinate location of the merchant and the coordinate location of the mobile device; and
communicating an alert whenever the determined distance exceeds a predetermined distance.

2. The method of claim 1, wherein the transaction device is a merchant point-of-sale (POS) terminal.

3. The method of claim 1, wherein the mobile device is a cell phone or a smart phone.

4. The method of claim 1, wherein the mobile device establishes a communication link with the transaction device in accordance with communication configuration information received by the NFC circuit via the NFC communication link.

5. The method of claim 1, wherein the determining the coordinate location of the merchant comprises determining longitude and latitude coordinates from information from the transaction device involving the payment card holder initiating the payment card transaction at the merchant using the mobile device.

6. The method of claim 1, wherein the determining the coordinate location of the mobile device comprises obtaining longitude and latitude coordinates from the cellular phone communication provider.

7. (canceled)

8. A method for authentication of a payment card transaction, said method comprising:
receiving information from a transaction device involving a payment card holder initiating a payment card transaction at a merchant using a mobile device;
communicatively coupling a Near Field Communication (NFC) circuit to the mobile device, the NFC circuit including at least one of a NFC tag and a NFC reader to receive or selectively provide wireless connectivity data from or to the transaction device via a NFC communication link;
determining coordinate location of the merchant by leveraging a physical address of the merchant;
determining coordinate location of the mobile device using an application programming interface (API) framework that is sufficient to support communication with a cellular phone communication provider, wherein the coordinate location of the mobile device is aged on an exponential scale to provide a confidence level of the coordinate location of the mobile device;
comparing the coordinate location of the merchant with the coordinate location of the mobile device to determine a relative degree of proximity of the merchant with the mobile device;
assessing the determined relative degree of proximity to facilitate determining whether the payment card transaction using the mobile device is valid or invalid; and
communicating an alert whenever the payment card transaction is invalid based solely on whether the relative degree of proximity exceeds a predetermined degree of proximity.

9. A system comprising:
a computer storage storing information for a plurality of payment card holders and a plurality of merchants, wherein information for at least one of the payment card holders comprises information about location of a mobile device used for initiating a payment card transaction at a merchant, and wherein the information for at least one of the merchants comprises information about location of the merchant or the payment card transaction using the mobile device; and
a processor coupled to the computer storage operable to:
receive information from a transaction device involving a payment card holder initiating a payment card transaction at a merchant using a mobile device;
communicatively couple a Near Field Communication (NFC) circuit to the mobile device, the NFC circuit including at least one of a NFC tag and a NFC reader to receive or selectively provide wireless connectivity data from or to the transaction device via a NFC communication link;
determine coordinate location of the merchant by leveraging a physical address of the merchant;
determine coordinate location of the mobile device using an application programming interface (API) framework that is sufficient to support communication with a cellular phone communication provider, wherein the coordinate location of the mobile device is aged on an exponential scale to provide a confidence level of the coordinate location of the mobile device;
compare the coordinate location of the merchant with the coordinate location of the mobile device to determine a relative degree of proximity of the merchant with the mobile device;
assess the determined relative degree of proximity to facilitate determining whether the payment card transaction using the mobile device is valid or invalid; and
communicate an alert whenever the payment card transaction is invalid based solely on whether the relative degree of proximity exceeds a predetermined degree of proximity.

10. The system of claim 9, wherein the transaction device is a merchant point-of-sale (POS) terminal.

11. The system of claim 9, wherein the mobile device is a cell phone or a smart phone.

12. The system of claim 9, wherein the mobile device establishes a communication link with the transaction device in accordance with communication configuration information received by the NFC circuit via the NFC communication link.

13. The system of claim 9, wherein the processor is operable to determine the coordinate location of the merchant by determining longitude and latitude coordinates from the information from the transaction device involving the payment card holder initiating the payment card transaction at the merchant using the mobile device, and to determine the coordinate location of the mobile device by obtaining longitude and latitude coordinates from the cellular phone communication provider.

14. The system of claim 9, wherein the relative degree of proximity is a determined distance between the coordinate location of the merchant and the coordinate location of the mobile device determined by the processor, and wherein the predetermined degree of proximity is a predetermined distance.

15. A non-transitory, machine-readable medium comprising a plurality of machine-readable instructions which when executed by one or more processors of a server are adapted to cause the server to perform a method comprising:
receiving information from a transaction device involving a payment card holder initiating a payment card transaction at a merchant using a mobile device;
communicatively coupling a Near Field Communication (NFC) circuit to the mobile device, the NFC circuit including at least one of a NFC tag and a NFC reader to receive or selectively provide wireless connectivity data from or to the transaction device via a NFC communication link;
determining coordinate location of the merchant by leveraging a physical address of the merchant;
determining coordinate location of the mobile device using an application programming interface (API) framework that is sufficient to support communication with a cellular phone communication provider, wherein the coordinate location of the mobile device is aged on an exponential scale to provide a confidence level of the coordinate location of the mobile device;
comparing the coordinate location of the merchant with the coordinate location of the mobile device to determine a relative degree of proximity of the merchant with the mobile device; and
assessing the determined relative degree of proximity to facilitate determining whether the payment card transaction using the mobile device is valid or invalid; and
communicating an alert whenever the payment card transaction is invalid based solely on whether the relative degree of proximity exceeds a predetermined degree of proximity.

16. The non-transitory, machine-readable medium of claim 15, wherein the transaction device is a merchant point-of-sale (POS) terminal.

17. The non-transitory, machine-readable medium of claim 15, wherein the mobile device is a cell phone or a smart phone, and wherein the mobile device establishes a communication link with the transaction device in accordance with communication configuration information received by the NFC circuit via the NFC communication link.

18. The non-transitory, machine-readable medium of claim 15, wherein determining the coordinate location of the merchant comprises determining longitude and latitude coordinates from the information from the transaction device involving the payment card holder initiating the payment card transaction at the merchant using the mobile device.

19. The non-transitory, machine-readable medium of claim 15, wherein determining the coordinate location of the mobile device comprises obtaining longitude and latitude coordinates from the cellular phone communication provider.

20. The non-transitory, machine-readable medium of claim 15, wherein the relative degree of proximity is a determined distance between the coordinate location of the merchant and the coordinate location of the mobile device determined by the one or more processors, and wherein the predetermined degree of proximity is a predetermined distance.
